(19) United States
(12) Patent Application Publication
(10) Pub. No.: US 2013/0313381 A1
(43) Pub. Date: Nov. 28, 2013

(54) ANTENNA HOLDING DEVICE

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventor: XIAO-LIAN HE, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/718,534

(22) Filed: Dec. 18, 2012

(30) Foreign Application Priority Data
May 28, 2012 (CN) 201210168258.3

(51) Int. Cl. H01Q 1/12

(52) U.S. Cl. CPC H01Q 1/1264
USPC 248/124.1

(57) ABSTRACT

An antenna holding device for holding test antennas includes a base, a first mounting pole, a second mounting pole, a guiding pole and an adjusting pole. The first mounting pole and the second mounting pole are mounted on the base. The guiding pole is mounted on the base and positioned between the first mounting pole and the second mounting pole. The adjusting pole is slidably and rotatably attached to the first mounting pole and the second mounting pole, and is slidably attached to the guiding pole.

### BACKGROUND

1. Technical Field

The present disclosure relates to antenna holding devices, and particularly to an antenna holding device for electromagnetic measurements.

2. Description of Related Art

In electromagnetic measurements, such as electromagnetic interference (EMI) measurements, test antenna needs to be mounted on a predetermined measuring location relative to a tested product to transmit and/or receive test signals. Furthermore, many relevant parameters (e.g., heights, and tilted angles) of the test antenna often need to be adjusted. A horizontal distance between the adjusted test antenna and the tested product is required to be very precise. However, frequently adjusting the test antenna easily changes the horizontal distance. This may cause a large error in the measurement.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

FIG. 1 is a schematic view of an antenna holding device, according to an exemplary embodiment.

FIG. 2 is a schematic view of the antenna holding device of FIG. 1 without a cover.

FIG. 3 is an exploded view of an adjusting pole, a first belt and a first block of FIG. 1.

FIG. 4 is a schematic view of the first belt and the first block of FIG.3 from another aspect.

FIG. 5 is an assembled view of the adjusting pole and a guiding pole shown in FIG. 1.

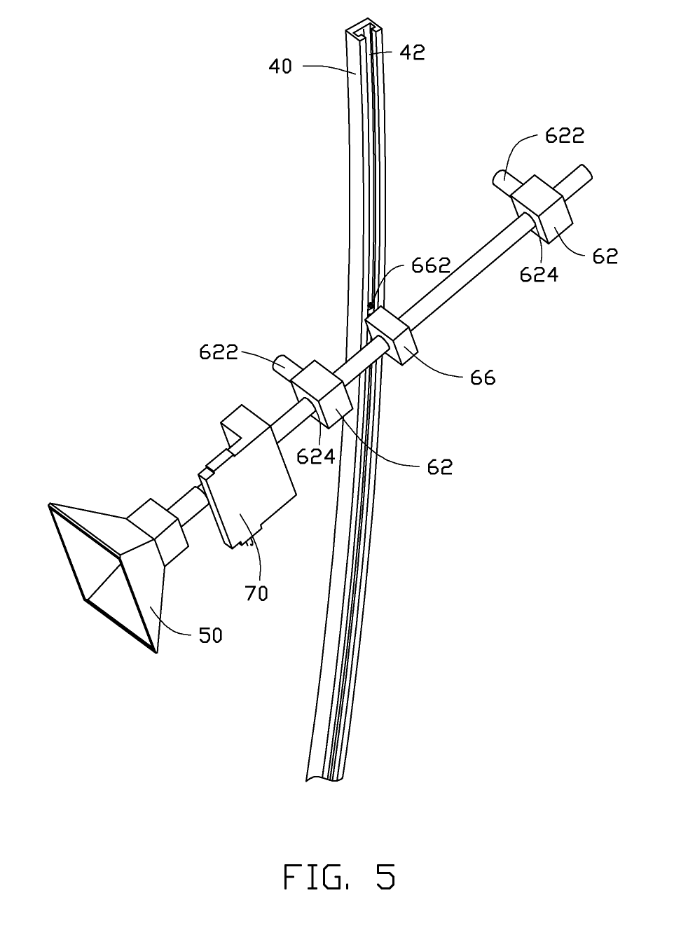

### DETAILED DESCRIPTION

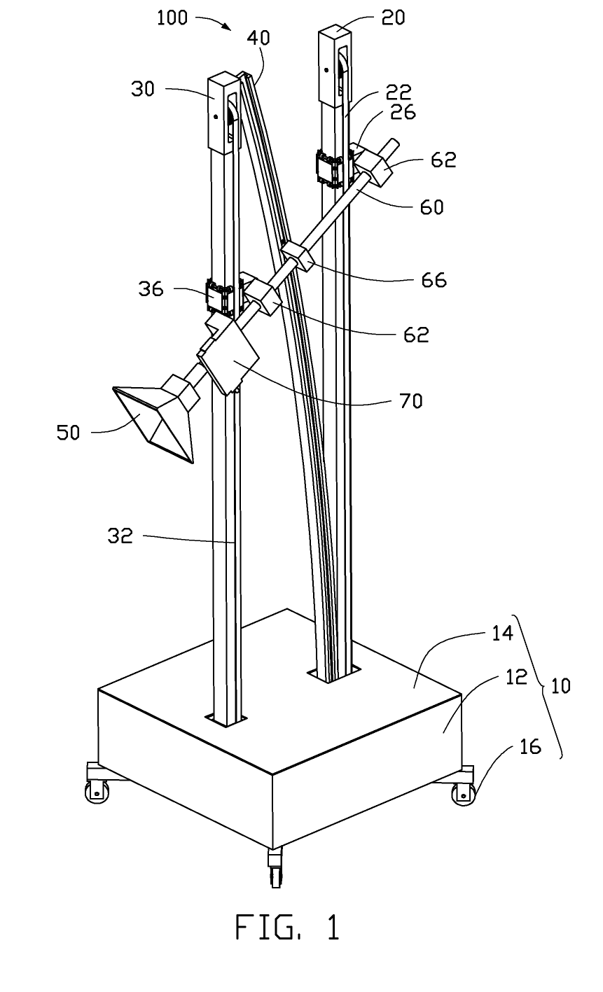

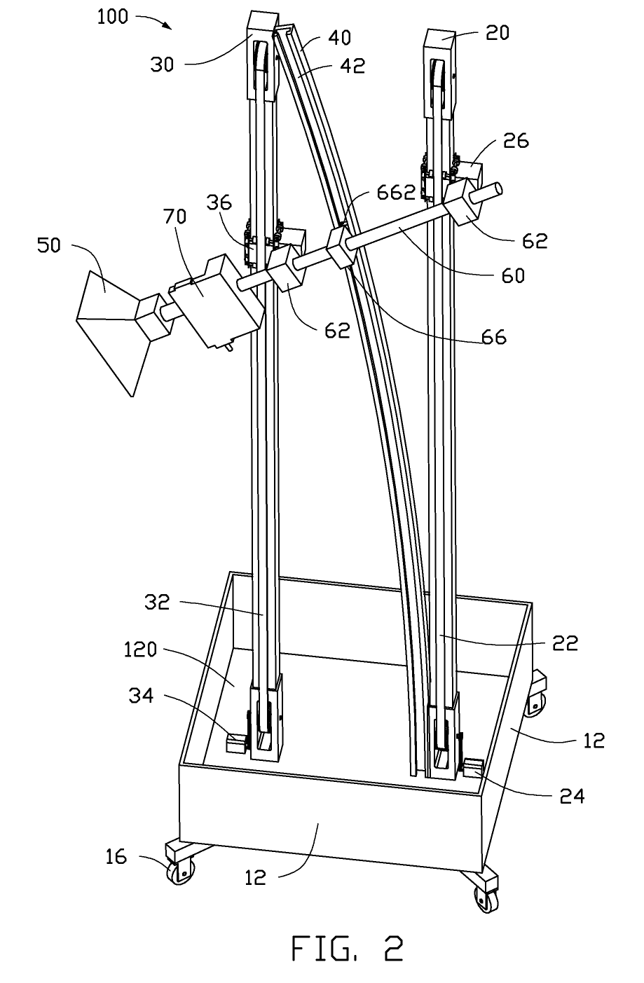

FIG. 1 and FIG. 2 show an antenna holding device 100, according to an exemplary embodiment. The antenna holding device 100 can be used to hold a test antenna for electromagnetic measurements, such as electromagnetic interference (EMI) measurements. In this embodiment, a test antenna 50 can be held on the antenna holding device 100.

The antenna holding device 100 includes a base 10, a first mounting pole 20, a second mounting pole 30, a guiding pole 40 and an adjusting pole 60. The first mounting pole 20, the second mounting pole 30 and the guiding pole 40 are respectively mounted on the base 10. The tested antenna 50 is mounted on the adjusting pole 60. The adjusting pole 60 with the tested antenna 50 is slidably and rotatably assembled on the first mounting pole 20 and the second mounting pole 30, for allowing the tested antenna 50 to be raised or lowered. The adjusting pole 60 is mounted on the guiding pole 40 for guiding the adjusting pole 60 to secure an invariable horizontal distance between the tested antenna 50 and a tested product.

The base 10 is substantially a cuboid-shaped casing and includes a seat 12, a removable cover 14, and a plurality of foot wheels 16. The seat 12 defines a receiving cavity 120. Ends of the first mounting pole 20, the second mounting pole 30, and the guiding pole 40 are mounted in the receiving cavity 120. The cover 14 is mounted on the seat 12 for covering the receiving cavity 120. The foot wheels 16 are respectively rotatably mounted on four distal ends of the seat 12, and thus the base 10 can be horizontally moved due to rotation of the foot wheels 16.

A first belt 22, a first motor 24 and a first block 26 are positioned on the first mounting pole 20. The first block 26 is slidably positioned on the first mounting pole 20. The first block 26 is mounted with the first belt 22, and they are configured to move together. The first motor 24 is positioned in the receiving cavity 120, of the seat 12, and drives the first belt 22 to move for raising or lowering the first block 26 along the first mounting pole 20.

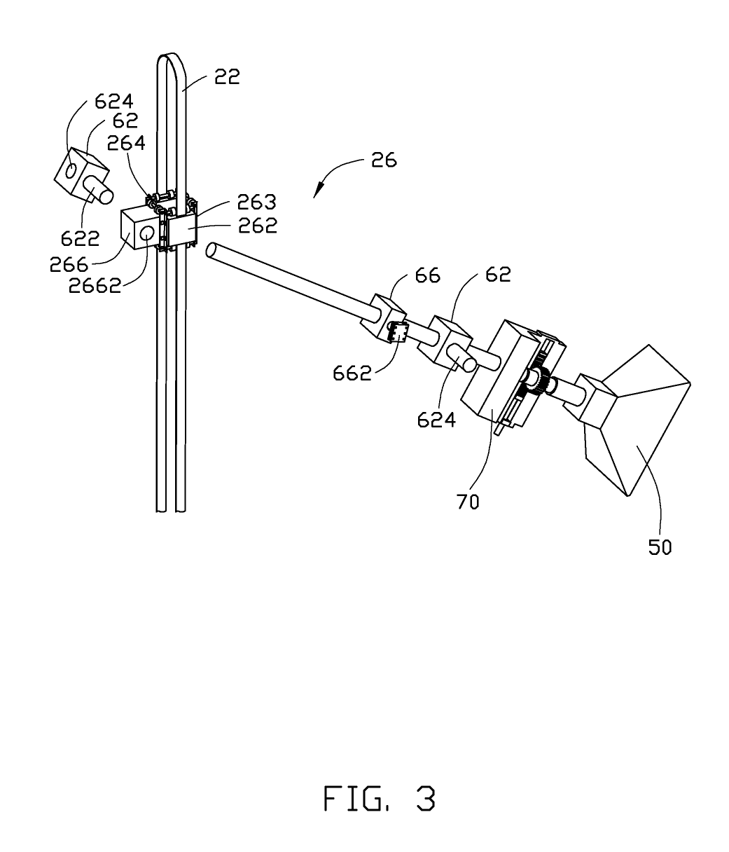

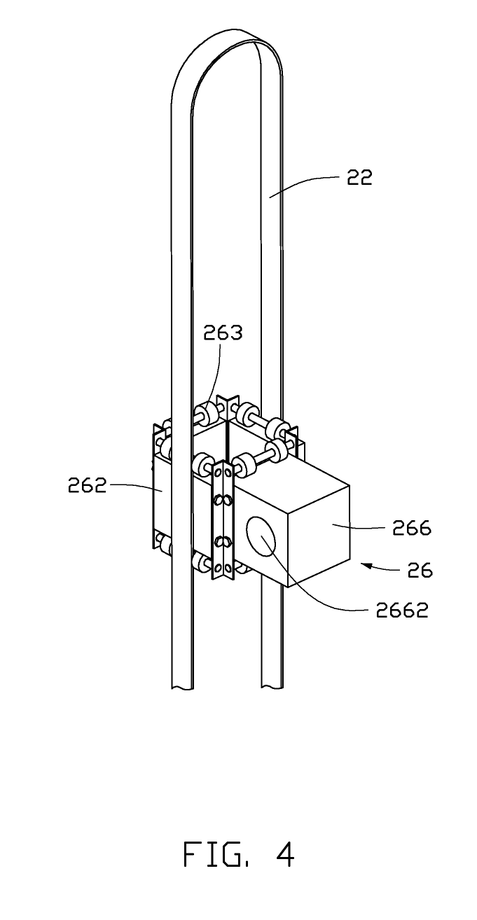

FIGS. 3 and 4 shows the first block 26 of the embodiment. The first block 26 includes two side plates 262 and two end plates 263. Opposite ends of each side plate 262 and each end plate 263 have a pair of wheels 264, for allowing the first block 26 to easily slide along the first mounting pole 20. A first side of the first belt 22 is mounted on one of the side plates 262, and a second side of the first belt 22 is spaced from the other of the side plates 262. A cubical protrusion 266 is integrally formed on one of the end plates 263. The protrusion 266 defines a through hole 2662.

The second mounting pole 30 is similar to the first mounting pole 20 and includes a second belt 32, a second motor 34 and a second block 36. The second motor 34 has a different speed from the first motor 24. This structure allows the first belt 22 and the second belt 32 to have different speeds to move.

Two connecting members 62, a latching member 66 and a cylinder 70 are positioned on the adjusting pole 60. Each connecting member 62 has a pivot 622 and defines a central hole 624. The adjusting pole 60 slidably extends through the central hole 624. One pivot 622 is rotatably connected to the through hole 2662 of the first block 26. The other pivot 622 is rotatably connected to the second block 36. The latching member 66 includes a guiding portion 662. The cylinder 70 is configured for rotating the adjusting pole 60.

The guiding pole 40 is positioned between the first mounting pole 20 and the second mounting pole 30. A first end of the guiding pole 40 is adjacent to a bottom end of the first mounting pole 20, and a second end of the guiding pole 40 is adjacent to a top end of the second mounting pole 30. The guiding pole 40 defines a sliding groove 42. The guiding portion 662 is slidably received in the sliding groove 42. The sliding groove 42 is substantially arcuate. An arc angle of the sliding groove 42 is computed according to the distance of the tested antenna and the tested product and a variable height. The arc angle may secure a projection of a reference point of the tested antenna 50 on a ground to keep invariable.

During assembly of the antenna holding device 100, the ends of the first mounting pole 20, the second mounting pole 30 and the guiding pole 40 are mounted in the base 10. The first motor 24 and the second motor 34 are received in the receiving cavity 120 and are respectively connected to the first mounting pole 20 and the second mounting pole 30 for driving the first belt 22 and the second belt 32. The tested antenna 50 is mounted one end of the adjusting pole 60. The two connecting members 62 and the latching member 66 are attached to the adjusting pole 60. Each connecting member 62 is rotatably connected to the first block 26 and the second block 36. The guiding portion 662 of the latching member 66 is slidably received in the sliding groove 42.

In use, since the first motor 24 and the second motor 34 have different speeds, the tested antenna 50 may be adjusted to a predetermined tilted angle. The guiding pole 40 further secures an invariable horizontal distance for precisely adjusting the position of the antenna 50.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An antenna holding device for holding a test antenna, comprising:
a base;
a first mounting pole and a second mounting pole, mounted on the base;
a guiding pole mounted on the base and positioned between the first mounting pole and the second mounting pole; and
an adjusting pole slidably attached to the guiding pole and slidably and rotatably attached to the first mounting pole and the second mounting pole.

2. The antenna holding device as claimed in claim 1, wherein a first belt, a first motor, and a first block connected to the first mounting pole; the first block is slidably positioned on the first mounting pole; the first block is mounted with the first belt; and the first motor is configured to drive the first belt to move for raising or lowering the first block along the first mounting pole.

3. The antenna holding device as claimed in claim 2, wherein a second belt, a second motor, and a second block are connected to the second mounting pole; the second block is slidably positioned on the second mounting pole; the second block is mounted with the second belt; the second motor is configured to drive the second belt to move for raising or lowering the second block along the second mounting pole; and the second motor has a different speed from the first motor.

4. The antenna holding device as claimed in claim 3, wherein each of the first block and the second block comprises two side plates and two end plates; a first side of the first belt and the second belt is mounted on one of the side plates; and a second side of the first belt and the second belt is spaced from the other of the side plates.

5. The antenna holding device as claimed in claim 4, wherein opposite ends of each side plate and each end plate have a pair of roll wheels, and the roll wheels are configured to slide along the first mounting pole or the second mounting pole.

6. The antenna holding device as claimed in claim 4, wherein a protrusion is integrally formed with one of the end plates, each protrusion defines a through hole, two connecting members are positioned on the adjusting pole, and each connecting member has a pivot rotatably connected to the through hole of each protrusion.

7. The antenna holding device as claimed in claim 6, wherein each connecting member defines a central hole, and the adjusting pole slidably extends through the central hole.

8. The antenna holding device as claimed in claim 1, wherein the base comprises a seat defining a receiving cavity; and ends of the first mounting pole, the second mounting pole, and the guiding pole are mounted in the receiving cavity.

9. The antenna holding device as claimed in claim 8, wherein the base comprises a removable cover and a plurality of foot wheels; the cover is mounted on the seat for covering the receiving cavity; and the foot wheels are respectively rotatably mounted on four distal ends of the seat.

10. The antenna holding device as claimed in claim 1, wherein the guiding pole defines a sliding groove, the sliding groove is arcuate, a latching member is positioned on the adjusting pole, and the latching member is slidably received in the sliding groove.
